(19) United States
(12) Patent Application Publication
(10) Pub. No.: US 2001/0042520 A1
(43) Pub. Date: Nov. 22, 2001

(54) Method for producing model animals for itching induced by disruption of cutaneous barrier function

(76) Inventors: Yasushi Kuraishi, Sugitani (JP); Takayuki Miyamoto, Nakaniikawa-gun (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/829,905

(22) Filed: Apr. 11, 2001

(30) Foreign Application Priority Data
May 17, 2000 (JP) 2000-145243

(51) Int. Cl. A01K 29/00

(52) U.S. Cl. 119/651

(57) ABSTRACT

The present invention provides itching model animals usable for evaluating the therapeutic effect of medicines, medicinal compositions, external preparations for the skin, etc. on itching induced by hypofunction of cutaneous barrier and also for evaluating the effect in improving the barrier function of the skin weakened and converted to be itchy by an external preparation for the skin or a cosmetic. The present invention also provides a method for producing such animals.

Itching symptoms are realized by degreasing the glabrous skin of each of small test animals with an organic solvent and then treating the skin with water to induce a lesion of the skin by the disruptions of the barrier function without inflammation.

### BACKGROUND OF THE INVENTION

The present invention relates to animal models useful for elucidating the mechanism of onset of dermatoses characterized by hypofunction of cutaneous barrier such as senile xeroderma and atopic dermatitis and also for developing a therapeutic agent for itching, and the production of the animal models.

The present invention also relates to a method for evaluating the itch-suppressing effect of a test medicine for developing a medical treatment for itching caused by a dermatosis characterized by hypofunction of cutaneous barrier.

A term “dry skin” is a generic name for expressing a condition of a skin having a reduced hydration of the stratum corneum caused by increase of transepidermal water loss which attribute to the cutaneous barrier disruption. Causes of the dry skin are aging of the skin such as senile xeroderma [Journal of Clinical Investigation, Vol. 95 (5); pages 2281 to 2290, 1995], and endogenous factors such as abnormality in the system of biosynthesizing sebaceous components as observed in patients suffering from atopic dermatitis [Journal of Investigative Dermatology, Vol. 96 (1), pages 10 to 15, 1991], chronic renal failure [Nephrology, Dialysis, Transplantation, Vol. 9 (9), pages 1302 to 1304, 1994] and cholestatic hepatopathy. In addition, it is known that the dry skin of also healthy person is caused by exogenous factors such as abnormally dry external environment in winter, and physical and scientific factors such as ungreasing of the sebaceous membrane caused by an excessively high frequency of bathing and use of a solvent. One of subjective symptoms of a major proportion of the patients with such hypofunction of cutaneous barrier is a generalized itchy sensation. This phenomenon brings problems of a serious unpleasant feeling and increment of the skin manifestations by the destruction of the barrier function caused by scratching.

Known barrier constituents are lipid components of sebaceous membrane such as cholesterol esters, triglycerides and free fatty acids and lipid components of intercellular lipids such as ceramides [Journal of Lipid Research, Vol. 30 (1), pages 89 to 96, 1989] and also water-soluble natural moisturizing factors contained in corneocytes composed of amino acids, lactic acid salts, urea and pyrrolidone carboxylic acid salts. It is apparent that the lack of these barrier constituents by the pathogenic or artificial reasons is the main cause of the dermatoses. However, on the other hand, no definite opinion has been established on the kind of a constituent which is the main cause of itchy sensation of the cases of the dermal diseases.

The mechanism of onset of the itching caused by the dermatoses is considered to be that an irritating substance and an allergen easily invade the skin when the barrier function weakens. Therefore, when skin care and treatment for assisting or recovering the barrier function are employed, the skin manifestations are improved and, in some cases, the itchy sensation is released. For example, when glycerol which is a standard humectant is applied, the recovery of the barrier function of the skin after the reduction is accelerated [Acta Dermato Venereologica, Vol. 79 (6), pages 418 to 421 (1999)] and the skin manifestations are recovered. However, on the other hand, the effect of glycerol on the itching has not yet been established.

It was considered in the prior art that the irritating substance and allergen which invaded the skin cause the degranulation of intracutaneous mast cells followed by the itching. However, in the cases of the dermatoses having itching, cutaneous reactions such as erythema or wheal caused by the degranulation of intracutaneous mast cells are not observed. Thus, the detailed onset mechanism has not yet been elucidated. Therefore, the itching caused by the dermatoses cannot be blocked with a histamine H₁ receptor antagonist generally used for relieving the itching caused by the degranulation of intracutaneous mast cells in many cases. Although it was reported that, for example, an opioid antagonist used in a trial administration was effective [Annals of Internal Medicine, Vol. 123 (3), pages 161 to 167, 1995], effective method of treatment has not yet been established.

It is known that the above-described hypofunction of cutaneous barrier brings about various functional changes of the skin. In particular, it was reported that the production of interleukin 1 or tumor necrosis factor α from epidermal keratinocytes is accelerated [Journal of Clinical Investigation, Vol. 90 (2), pages 482 to 487, 1992] and that the epidermis is thickened as the proliferation of epidermal keratinocytes is accelerated [Archive of Dermatological Research, Vol. 288 (5-6), pages 230 to 238, 1996]. However, no evidence for directly proving the relationship between the above-described change and itching has been found.

One of the reasons for that the mechanism of the onset of itching caused by dermatoses induced by the hypofunction of cutaneous barrier is lack of laboratory animal models suitable for the evaluation. Publicly known methods in which animal models are used for destroying the barrier function of the skin of an animal model include, for example, a method wherein the stratum corneum is physically peeled off by tape stripping technique, and a method wherein the lipid components working for the barrier function of the skin are defatted with an organic solvent such as acetone [Archive of Dermatological Research, Vol. 288 (5-6), pages 230 to 238, 1996] or a surfactant. However, the relationship between the skin manifestations and itching of these laboratory animals is still unknown.

On the other hand, for the determination of the itching of small laboratory animals, a method is known, wherein number of times of scratching behaviour of mice, which is a itch-associated action, caused by intradermal injection of a pruritogenic substance, is employed as the index [European Journal of Pharmacology, Vol. 275 (3), pages 229 to 233, 1995]. However, in this method, the itch-associated action is caused by intradermal injection of an pruritogenic substance, such as an inducer for degranulation of cutaneous mast cells, e.g. compound 48/80 which induces the degranulation of mast cells and serotonin [Neuroscience Research, Vol. 35 (2), pages 77 to 83, 1999], substance P [Journal of Pharmacology & Experimental Therapeutics, Vol. 286 (3), pages 1140 to 1145, 1998] or leukotriene B₄ [European Journal of Pharmacology, Vol. 353 (1), pages 93 to 96, 1998]. Such methods are effective when the mechanism and cause of onset of itching have been elucidated or when the itching action of a specified substance is to be determined. However, in fact, such methods cannot be used for the proper evaluation or for elucidating the onset mechanism because the onset mechanism has not yet been elucidated.

### SUMMARY OF THE INVENTION

The object of the present invention is to provide itching model animals usable for evaluating the therapeutic effect of medicines, medicinal compositions, ointments for the skin, etc. on itching induced by hypofunction of cutaneous barrier and also for evaluating the effect of improving the barrier function of the skin weakened by an ointment for the skin or a cosmetic. Another object of the invention is to provide a method for producing such animals.

The present invention has been completed after intensive investigations made for the purpose of obtaining models which take the itch-associated scratching action by realizing skin manifestations similar to that of the above-described dermatoses of small laboratory animals by overcoming the defects of the prior art.

Namely, the present invention provides a method for producing a model animal for itching induced by an inflammation-free dermal lesion caused by destruction of cutaneous barrier functions, which method comprises degreasing a small test animal by applying an organic solvent to the glabrous skin of the animal and then treating the skin with water. The present invention also provides the model animal having itchy symptoms caused by hypofunction of cutaneous barrier, which animal is obtained by this method.

Another object of the present invention is to provide a method for evaluating the itch-suppressing effect of a test medicine and a method for evaluating a test substance useful to improve so-called skin care products.

### BRIEF DESCRIPTION OF THE DRAWINGS

FIG. 1 represents the number of times of the scratching action of mice treated with acetone / diethylether mixture and distilled water twice in daily for 5 days on the rostral back skin, as compared with the results of the same tests of mice which had been only shaved, mice treated with acetone / diethylether mixture twice in daily for 5 days and mice subjected to the tape stripping in which 4 times of continuous peeling the stratum corneum by adhesive cellophane tape was conducted once in daily for a period of 5 days. The average±standard error of the number of scratching action of 7 to 8 mice bouts per 120 minutes in each case is shown. INT represents a negative control group in which the mice was only shaved, AEW represents a group in which mice were treated with acetone / diethylether mixture and distilled water, AE represents a group in which mice were treated with acetone / diethyl ether mixture, and TS represents a group in which mice were subjected to the tape stripping treatment. Symbol * in FIG. 1 indicates that the difference between each group is statistically significant (p<0.05).

FIG. 2 shows the results of the tests on the effect of Terfenadine, which is a histamine H₁ receptor antagonist, and Naloxone, which is an opioid receptor antagonist, premedicated for suppressing the scratching action of mice treated with acetone / diethylether mixture and distilled water twice in daily for 5 days on the rostral back skin. A number of times of scratching action of 8 mice in 120 minutes is shown by the average percentage±standard error based on the average (100%) of the control group. CONT represents control group, TER represents a group of mice to which 10 mg/kg of Terfenadine was perorally administered, and NAL represents a group of mice to which 1 mg/kg of Naloxone was subcutaneously injected. Symbol * in FIG. 2 indicates that the difference from the control group is statistically significant (p<0.05).

FIG. 3 shows the daily change in hydration of the stratum corneum of each mouse which was subjected to the disruption of cutaneous barrier function by treatment with acetone / diethylether mixture and distilled water twice a day for 5 days. FIG. 3 also shows the results of determination of the effect obtained by the application of 10% aqueous glycerol solution on the scratching action on the next day after the completion of 5 days treatment for disrupting the barrier function. In FIG. 3-A, the daily change in hydration of the stratum corneum of 6 cases of mice is shown in terms of the relative electrostatic capacitance, in which ∘ represents the control group, ▴ represents the group in which glycerol was applied to the mice for one day, and ▪ represents the group in which glycerol was applied to the mice for 5 days. FIG. 3-B shows the number of the scratching action per 120 minutes, wherein CNT represents the control group, 1 D represents the group in which glycerol was applied for one day, and 5 D represents the group in which glycerol was applied for 5 days. Symbol * in FIG. 3 indicates that the difference from the control group is statistically significant (p<0.05).

### DESCRIPTION OF THE PREFERRED EMBODIMENTS

Small animals generally used for experiments are also usable in the method of the present invention. The animals are, for example, small laboratory animals such as mice, rats, guinea pigs and hamsters. In these animals, mice are the most suitable. Small animals having glabrous skin are used in the present invention. The term “glabrous skin” herein indicates the skin of a hereditary hairless animal and also the skin of a small laboratory animal from which hair was artificially removed by shaving or with a depilatory drug. Small animals having the skin from which hair was removed with a razor or the like or those having the glabrous skin realized with a depilatory drug or the like are preferably used because the location in which the barrier function is destroyed can be easily specified in the observation. The small laboratory animals can be controlled by an ordinary breeding method. It is preferred that they get used to the behavioral observation environment, such as the presence of a video camera used in the present invention, before the experiments.

The location in which the barrier function is destroyed is preferably such that the small laboratory animal can scratch with his hind limbs so that the effect of the treatment can be easily observed in the method of the present invention. The location is particularly preferably around rostral back, flank or ventral part. Although the area to be treated is not particularly limited, it is desirably about 40 to 80% based on the width or height of the small laboratory animal. In case of mice, the area is about 2 cm×2 cm.

The organic solvent used for the treatment is not particularly limited so far as the solvent per se does not have a strong corroding effect on the skin. The organic solvents include alcohols, ketones, ethers and esters, preferably aliphatic hydrocarbons and DMSO, more preferably, acetone or mixtures of acetone and an ether, and particularly preferably a mixture of acetone and diethylether in a ratio of 1:1. In the treatment with the organic solvent or water, the part to be treated is covered with an absorbent cotton containing it, and then the superfluous solvent or water is wiped off or dripped off. Preferably, the part is covered with the absorbent cotton containing the solvent or water and then the superfluous solvent or water is wiped off. The time required of the treatment is not strictly limited and is variable depending on the kind of the small animals and the organic solvent used. The time required of the treatment with the organic solvent is generally at least several seconds, preferably about several seconds to several minutes, and particularly about 10 to 60 seconds. The time required of the treatment with water is at least 30 seconds, preferably about 30 seconds to several minutes, and particularly about 30 to 60 seconds. The treatment is repeated until the corneal layer of epidermis has become whity and powder-coated or, in other words, until wrinkle formation or squamae is observed on the skin.

The intervals between the treatment with the organic solvent and the subsequent treatment with water are shorter than a period in which the barrier function is completely recovered. The treatments are desirably continuously repeated with such a frequency that the inflammatory stimulation is not given to the skin until at least skin manifestations caused by drying such as scales have become to be observed. The frequency of the treatments varies depending on the kind of the small animals. Usually, the treatments are repeated with a frequency of 1 to 3 times in daily for several days (preferably at least 3 days). The onset of the dermatoses caused by the disruption of the barrier function can be confirmed by the visual observation of the appearance of the skin, and the determination of hydration of the stratum corneum and transepidermal water loss according to the present invention. A combination of two or more methods is desirable. The formation of wrinkles and scales are apparently observed on the skin after the disruption of the barrier function by, for example, the method of the present invention. Therefore, these symptoms can be employed as the index at first.

The hydration of the stratum corneum can be determined by a technique of conductimetry, determination of electrostatic capacitance or FT-IR method. Water loss through the epidermis can be noninvasively determined with an electric measuring instrument or the like so as not to affect the scratching action. The water loss through the epidermis is desirably still increasing one day after the barrier disrupting treatment, unlike the untreated animals. Preferably, the transepidermal water loss in the treated animals is at least 2-fold much as that of the untreated animals. On the other hand, hydration of the stratum corneum of the treated animals is desirably lower than that of the untreated animals one day after the barrier disruption treatment. Namely, hydration of the treated animals determined on the basis of the electrostatic capacitance is preferably less than ½ of that of the untreated animals one day after the barrier disruption treatment.

On the other hand, the small test animals having the xeroderma-like lesion caused by the treatment for disrupting the barrier function of the skin according to the present invention show spontaneous behaviour of scratching to the lesional skin with their hind limbs. Accordingly, the degree of itchiness induced by the dermatosis can be determined on the basis of the change in the state of the skin by the scratching action and also number of the scratching action. Although the number of scratching action can be directly visually observed, it is preferred to observe and to record the animals in an unattended environment. Concretely, for example, the observation and recording are desirably carried out by recording the action of the animals in a cage having an open or transparent top with a video camera placed above the cage. As for the observation of the action, the small test animals desirably get used to the behavioral observation environment before counting the number of times of the scratching action. One scratching action means a series of action beginning when the small animal raises its hind limb for starting the scratching and ending when the animal lowers its hind limb. The scratching action is determined by counting the number of the scratching of the region of the disrupted barrier function and surrounding parts with hind limbs. The determination period for each animal is at least 30 minutes, preferably 30 to 150 minutes. Several small animals, usually about 4 to 12 small animals, are used for each test and the results are statistically calculated.

The effect of a medicine on suppressing the itching according to the present invention can be determined as follows: The effect of such a medicine can be evaluated on the basis of the number of the scratching of an itchy region caused by the disruption of the barrier function of the model animals obtained by the method of the present invention and also degree of the reduction of the number. For example, when a specified test medicine is administered to model animals produced by the present invention by a specified administration method and the number of the scratching action of the model animals is judged to be statistically significantly reduced (significant level: 5%), it can be concluded that the medicine is effective. The administration method can be selected from among intravenous injunction, subcutaneous injection, intradermal injection, oral administration, percutaneous administration and pernasal administration depending on the properties of the test medicine. In the percutaneous administration, a medicine to be tested is applied to the skin having a barrier function disrupted by the method of the present invention. In a control group, animals to which the medicine was not administered are used. In a comparative group, animals to which a histamine H₁ receptor antagonist used for suppression of the itching caused by the degranulation of intracutaneous mast cells was administered can be used. Further, the degrees of reduction in the number of scratching action obtained by using medicines can be directly compared with each other for the relative evaluation. In the diagnosis of the skin appearance, the control of the formation of scales or the like or disappearance thereof is employed as the index. When no abnormal finding is obtained at all, the medicine can be determined to have a remarkable effect. As for hydration of the stratum corneum, the effect of a medicine is determined on the basis of the protection from lowering of hydration by the barrier-disruption process or degree of the recovery, and the medicine can be determined to have a remarkable effect when the hydration after the completion of the administration is substantially equal to that determined before the cutaneous barrier disrupting treatment. Particularly for the evaluation of the effect of a medicine, quasi drug or cosmetic composition for improving the general skin manifestations, it is desirable to evaluate the combination of indexes of skin lesions caused by the disruption of the cutaneous barrier function thereof such as hydration of the stratum corneum, transdermal water loss and diagnosis of appearance of the skin with the number of scratching action. For example, both of (1) inhibition of formation of scales or the like or disappearance of scales in the diagnosis of the skin appearance and (2) degree of inhibition of reduction in hydration by the cutaneous barrier disruption or degree of recovery therefrom in the determination of hydration in the stratum corneum, are employed as the indexes. When no abnormality is found in the diagnosis (1) and the results of (2) after the completion of the administration are similar to those of animals which were free from the barrier destruction treatment, the medicine can be judged to be remarkably effective.

The following Examples will further illustrate the method of the present invention for producing the itching model animals, and method of evaluating the effect of a medicine for suppressing the itching of the model animals.

### EXAMPLE 1

A rostral part (4 cm², i.e. 2 cm×2 cm) of the back skin in each of 10 male ICR mice was shaved. Four days after the shaving, the following test was started: The skin was covered with a 2 cm×2 cm absorbent cotton impregnated with a mixture of acetone and diethylether (1:1) for 15 seconds. The skin was wiped to remove superfluous solvent, then covered with an absorbent cotton impregnated with distilled water for 30 seconds, and wiped in the same manner as that described above. This treatment for disrupting the cutaneous barrier function of the skin was conducted twice in daily at intervals of at least 8 hours for 5 days. In a control group, only the shaving was conducted.

On the next day after the completion of the 5 days treatment for disrupting the skin barrier function, each mouse was placed in each section of an acrylic acid resin cage (26×18×33 cm) divided into four sections (each section: 13×9×33 cm). After the mice was acclimatized to the cage in unmanned environment for 60 minutes, the action of each mouse was recorded for 120 minutes with a 8 mm video camera placed above the cage in such a manner that the 4 sections are in one scene. The scratching action was observed by playing back the video tape. The number of the scratching action by which the tip of a toe of a hind limb of the mouse touched the shaved part of the skin in 120 minutes was counted by the visual observation. One scratching action was a series of action beginning when the mouse raised its hind limb for starting the scratching and ending when the animal lowers its hind limb.

Separately, a rostral part (4 cm², i.e. 2×2 cm) on the back of each of 10 male ICR mice in another group was shaved. Four days after the shaving, a tape stripping test started. In this test, an adhesive cellophane tape was continuously 4 times applied to and peeled the stratum corneum from the rostral part on the back of each mouse. This series of the test was conducted once a day for 5 days. The scratching action of the animals thus treated in a control group was also observed in the same manner as that described above. In still another group, it was begun to cover the skin with a 2 cm×2 cm absorbent cotton impregnated with a mixture of acetone and diethylether (1:1) for 15 seconds 4 days after the shaving. The skin was wiped to remove superfluous solvent. This treatment for disrupting the cutaneous barrier function of the skin was conducted twice in daily at intervals of at least 8 hours for 5 days. Then the scratching action of the mice was observed. Namely, the action of each mouse was recorded for 120 minutes with a 8 mm video camera in he same manner as that described above. The number of the scratching action bouts per 120 minutes was counted by the visual observation.

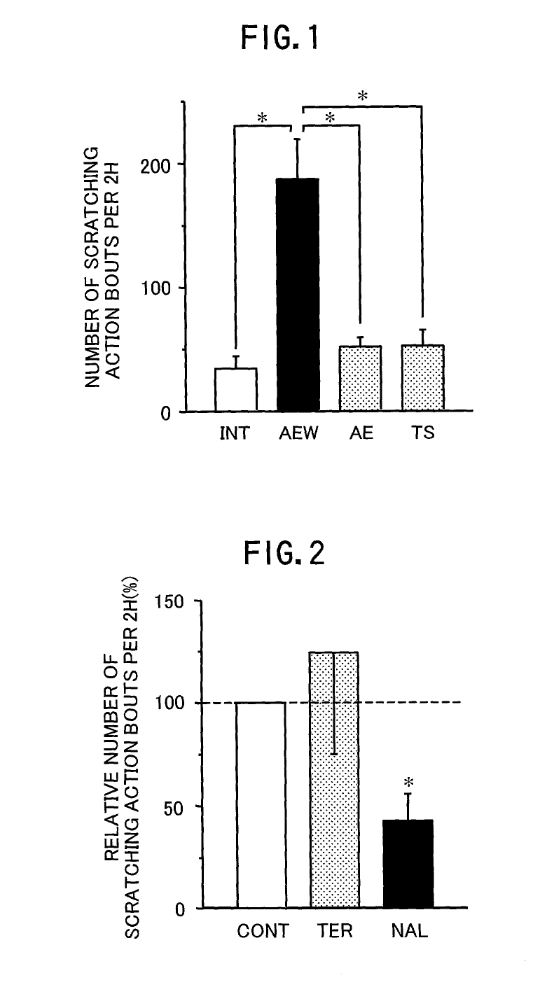

The results are shown in FIG. 1. The number of times of the scratching action of the group of mice which were shaved but not subjected to the barrier disrupting treatment (INT, FIG. 1) was 34.4±9.8 times/120 minutes, that of the group of mice (AEW) treated with the mixture of acetone and ether (1:1) and then with distilled water was 156.9±32.3 times/120 minutes, that of the group of mice treated with the mixture of acetone and ether was 51.7±7.5 times/120 minutes, and that of the group of mice subjected to the tape stripping treatment for 5 days was 52.5±12.7 times/120 minutes. Thus, the number of the scratching action in the mice treated with the mixture of acetone and diethylether (1:1) and then with distilled water was far larger than the numbers in other treated and untreated groups.

It is apparent from the results obtained above that the treatment of the shaved rostral part on the back of each mouse with the acetone / ether mixture followed by the treatment with distilled water more easily induces the skin region which easily causes the scratching action, than the known methods of the physical barrier function-disrupting treatment by the tape stripping and the barrier function-disrupting treatment by only the degreasing with the organic solvent.

### EXAMPLE 2

The effect of Terfenadine, which is a histamine H₁ receptor antagonist, and that of Naloxone, which is an opioid antagonist, for relieving the itching were determined with the same test materials as those in Example 1. The barrier function-disrupting treatment was conducted in the same manner as that of Example 1. On the next day after the completion of the 5 days barrier function disrupting treatment, the scratching action of mice was recorded for 120 minutes in the same manner as that of Example 1. The observation of the behavior of the mice and the counting of the number of times of the scratching action were conducted in the same manner as that of Example 1. 10 mg/kg of Terfenadine which is the histamine H₁ receptor antagonist, was perorally administered at 30 minutes before the starting to record the scratching action, or 1 mg/kg of Naloxone, which is an opioid receptor antagonist, was subcutaneously injected at 15 minutes before the starting to record the scratching action. The inhibitory effect of each medicine on itching was represented by the relative number of scratching action, while the average of the number of scratching action in the control group to which no medicine was given was represented as 100%.

The test results were as follows: The number of the scratching action induced by the disruption of the cutaneous barrier function of mice which were administrated Terfenadine, a histamine H₁ receptor antagonist, was 124.2±49.3% based on that of the control group. Thus, no suppressing effect was recognized. On the other hand, the number of the scratching action induced by the disruption of the cutaneous barrier function of mice which Naloxone were injected, an opioid receptor antagonist, was reduced to 42.5±13.1% based on that of the control group. The difference from the control group was statistically significant (level of significance: 5%). (see FIG. 2).

It was thus proved that the histamine H₁ receptor antagonist which is clinically ineffective against itching caused by the hypofunction of cutaneous barrier is also ineffective against the scratching action in the present invention. It was also proved that the opioid receptor antagonist clinically effective against itching induced by hypofunction of cutaneous barrier is also effective against the scratching action in the present invention.

### EXAMPLE 3

The effect of glycerol (humectant) on the skin manifestations and itching induced by the barrier disruption treatment of the present invention was determined by using the test animals similar to those used in Example 1. The barrier function-disrupting treatment was conducted twice in daily in the same manner as that of Example 1 continuously for 5 days. The skin manifestations were examined by the visual observation and the determination of hydration of the stratum corneum based on the relative electrostatic capacitance determined with Corneometer CM 825 (Courage+Khazaka Electronics, Cologne, Germany). Hydration of the stratum corneum was determined before starting the first barrier disrupting treatment every day and on the next day after the completion of the five days barrier disruption treatment. As for the scratching action, the scratching action of each mouse was filmed and recorded for 120 minutes in the same manner as that in Example 1 on next day after the completion of the five days barrier disruption treatment. The observation of the action and counting of the number of the scratching action were conducted in the same manner as that of Example 1. Glycerol was used in the form of 10% aqueous solution thereof. In the group of 5 days application, 50 μl of glycerol was applied to the part of the barrier disruption in open method one hour after the barrier disruption treatment each time. In the group of 1 day application, 50 μl of glycerol was applied to the part of the barrier destruction in open method one hour after the barrier destruction treatment conducted twice on the fifth day.

The results of the test were as follows: Hydration of the stratum corneum in the control group was 44.5±1.9 before starting the treatment of cutaneous barrier disruption, which was reduced to 15.5±2.1 on the next day after the completion of the 5 days barrier disruption treatment. In the group in which 10% aqueous glycerol solution was applied, the formation of scales and wrinkles induced by the cutaneous barrier disruption was completely inhibited. In this group, hydration of the stratum corneum, which was 40.0±1.2 before starting the treatment of cutaneous barrier disruption, was not lowered and it was 44.7±3.0 on the next day after the completion of the 5 days barrier disrupting treatment. The number of the scratching action bouts per 120 minutes was 126.5±20.8 in the control group, and it was 42.5±10.0 in the group in which 10% aqueous glycerol solution was applied for 5 days. The difference between the two groups was statistically significant. On the other hand, in the group wherein 10% aqueous glycerol solution was applied for one day, hydration of the stratum corneum once reduced to 20.5±1.3 from 43.5±1.3 by the 4 days barrier function disrupting treatment was recovered to 41.3±2.6 (close to the hydration before starting the treatment of cutaneous barrier disruption), but slight scales and wrinkle formation was observed. The number of the scratching action bouts per 120 minutes was 76.5±14.6. Thus, the difference from the control group was statistically significant, though the effect of suppressing the itching was incomplete.

It was understood from these results that when glycerol, clinically effective in improving the skin manifestations induced by hypofunction of cutaneous barrier, is applied to the models of this experiment for 5 days starting in the initial stage of the barrier disrupting treatment, the appearance of all the skin manifestations of the model was controlled. However, when glycerol was applied for one day after the appearance of the skin manifestations induced by the disruption of the barrier function, it was remarkably effective on hydration of the stratum corneum but other properties of the skin such as protection from scale and wrinkle formation were not improved. Glycerol was partially effective in removing the itching.

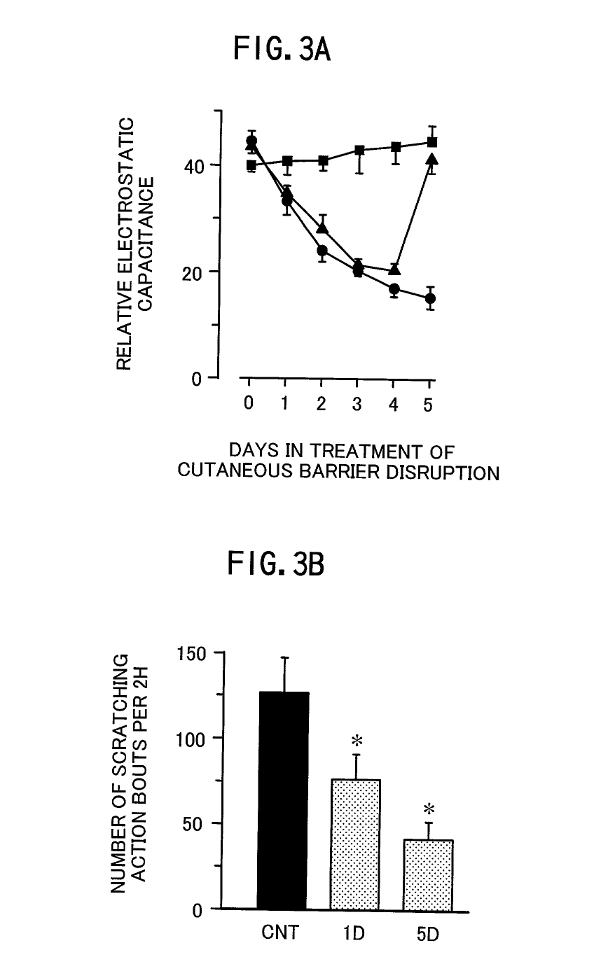

Namely, when the skin care is started before the onset of the skin manifestations, a remarkable effect on inhibiting the barrier disruption treatment is obtained. After the onset of the skin manifestations, a remarkable effect was obtained only on the hydration of the stratum corneum probably because of the improvement of the barrier function. Accordingly, it is estimated that the onset of the skin manifestations induced by the barrier disrupting treatment of the present invention can be prevented or the symptoms can be improved by the humectant skin care effective for human beings. The suppressing effect of a medicine which can be determined by the present invention is considered to be parallel with the suppressing effect thereof on the dermatoses. Also, the effect of a humectant skin care component evaluated on the basis of the scratching action as the index according to the present invention is considered to be parallel with the effect on the itching induced by the disruption of the barrier function. The results are shown in FIG. 3.

The present invention provides animal models capable of efficiently realizing the scratching action related to the itching, while the onset of the itching could not be clearly recognized in animal models having disrupted barrier function in the prior art. Namely, the animal models obtained by the present invention have an itchy sensation close to the itchy sensation of most patients with dermatoses who are characterized by a hypofunction of cutaneous barrier.

Therefore, when the animal models obtained by the present invention are used, test results close to those obtained by clinical tests of human beings can be obtained in the treatment of itching and also in the determination of effectiveness of a preventive drug. The model animals of the present invention can contribute to the reduction in unpleasant feeling of patients with dermatoses and also to the removal of aggravating factors from the patients.

According to the present invention, model animals of a dermatosis suffering from itching for unknown causes can be produced.

Further, according to the present invention, effects of a therapeutic agent on itching induced by hypofunction of cutaneous barrier can be determined, while the evaluation of such effects was difficult in the prior art.

What is claimed is:

1. A method for preparing a model animal for itching induced by hypofunction of cutaneous barrier, which comprises:
(i) applying an organic solvent to the glabrous skin of a small test animal,
(ii) applying water to the glabrous skin to which the organic solvent was applied, and
(iii) repeating treatments (i) and (ii) for several days until the formation of wrinkles and scales is observed on the glabrous skin and/or until hydration of the stratum corneum of the glabrous skin on a day next to the treatment day is reduced to less than ½ of that of untreated glabrous skin.

2. The method for preparing a model animal for itching according to claim 1, wherein the hydration of the stratum corneum is determined by determining the electrostatic capacitance.

3. The method for preparing a model animal for itching according to claim 1, wherein the organic solvent is selected from the group consisting of alcohols, ketones, ethers, esters and DMSO.

4. The method for preparing a model animal for itching according to claim 1, wherein the organic solvent is a mixture of acetone and diethylether in a ratio of 1:1.

5. The method for preparing a model animal for itching according to claim 1, wherein the area to be treated is about 40% to 80% based on the width or height of an animal.

6. The method for preparing a model animal for itching according to claim 1, wherein the period of the treatment is at least 3 days.

7. The method for preparing a model animal for itching according to claim 1, wherein the treatment time in step (i) is 10 to 60 seconds, the treatment time in step (ii) is 30 to 60 seconds, and the steps (i) and (ii) are repeated once to three times a day.

8. A method for preparing a model animal for itching induced by hypofunction of cutaneous barrier, which comprises:
(i) applying a mixture of acetone and diethylether in a ratio of 1:1 to the glabrous skin of a small test animal,
(ii) applying water to the glabrous skin to which the organic solvent was applied, and
(iii) repeating treatments (i) for 10 to 60 seconds, and (ii) for 30 to 60 seconds, until wrinkle formation or scale is observed on the glabrous skin and/or until hydration of the stratum corneum of the glabrous skin on a day next to the treatment day is reduced to less than ½ of that of untreated glabrous skin.

9. The method for preparing a model animal for itching according to claim 8, wherein the area to be treated is about 40% to 80% based on the width or height of the animal.

10. The method for preparing a model animal for itching according to claim 1, wherein the small animal is selected from the group consisting of mice, rats, guinea pigs and hamsters.

11. A method for preparing a model animal for itching induced by hypofunction of cutaneous barrier, which comprises:
(i) applying a mixture of acetone and diethylether in a ratio of 1:1 to the glabrous skin of a small test animal, the area of the glabrous skin being about 40% to 80% based on the width or height of the animal,
(ii) applying water to the glabrous skin to which the organic solvent was applied, and
(iii) repeating treatments (i) and (ii), until wrinkle formation or scale is observed on the glabrous skin and/or until hydration of the stratum corneum of the glabrous skin on a day next to the treatment day is reduced to less than ½ of that of untreated glabrous skin.

12. A method for preparing a model mouse for itching induced by hypofunction of cutaneous barrier, which comprises:
(i) applying a mixture of acetone and diethylether in a ratio of 1:1 to the glabrous skin of a small test animal,
(ii) applying water to the glabrous skin to which the organic solvent was applied, and
(iii) repeating treatments (i) for 10 to 60 seconds, and (ii) for 30 to 60 seconds, until wrinkle formation or scale is observed on the glabrous skin and/or until hydration of the stratum corneum of the glabrous skin on a day next to the treatment day is reduced to less than ½ of that of untreated glabrous skin.

13. The method for preparing a model mouse for itching according to claim 12, wherein the area to be treated is about 40% to 80% based on the width or height of the mouse.

14. A method for evaluating the itch-suppressing effect of a test medicine, which comprises:
(i) providing model animals obtained by the method of claim 1,
(ii) administrating a test medicine to the model animals,
(iii) comparing the number of itch-associated action of the model animals to which the test medicine was applied with that of untreated model animals,
(iv) judging the test medicine to be effective in suppressing the itching when the number of itch-associated action of the model animals to which the test medicine was applied is statistically significantly smaller than that of the comparative model animals to which the test medicine was not applied.

15. A method for evaluating the itch-suppressing effect of a test medicine, which comprises:
(i) providing model animals obtained by the method of claim 8,
(ii) administrating a test medicine to the model animals,
(iii) comparing the number of itch-associated action of the model animals to which the test medicine was applied with that of untreated model animals,
(iv) judging the test medicine to be effective in suppressing the itching when the number of itch-associated action of the model animals to which the test medicine was applied is statistically significantly smaller than that of the comparative model animals to which the test medicine was not applied.

16. A method for evaluating the itch-suppressing effect of a test medicine, which comprises:
(i) providing model animals obtained by the method of claim 11,
(ii) administrating a test medicine to the model animals,
(iii) comparing the number of itch-associated action of the model animals to which the test medicine was applied with that of untreated model animals,
(iv) judging the test medicine to be effective in suppressing the itching when the number of itch-associated action of the model animals to which the test medicine was applied is statistically significantly smaller than that of the comparative model animals to which the test medicine was not applied.

17. A method for evaluating the itch-suppressing effect of a test medicine, which comprises:
(i) providing model mice obtained by the method of claim 12,
(ii) administrating a test medicine to the model animals,
(iii) comparing the number of itch-associated action of the model animals to which the test medicine was applied with that of untreated model animals,
(iv) judging the test medicine to be effective in suppressing the itching when the number of itch-associated action of the model animals to which the test medicine was applied is statistically significantly smaller than that of the comparative model animals to which the test medicine was not applied.

18. A method for evaluating a test substance to improve skin care products, which comprises,
(i) applying an organic solvent to the glabrous skin of small test animals,
(ii) applying water to the glabrous skin to which the organic solvent was applied,
(iii) for a test group, applying a test substance to the glabrous skin to which the water was applied,
(iv) repeating treatments (i) and (ii) for several days for a control group and (i) to (iii) for the test group for several days,
(v) comparing the number of itch-associated action of the animals of the test group with that of the animals of the control group, and
(vi) judging the test substance to be effective in improving skin care products when the number of itch-associated action of the animals of the test group is statistically significantly smaller than that of the animals of the control group.

19. A method for evaluating a test substance to improve skin care products, which comprises,
(i) applying a mixture of acetone and diethylether in a ratio of 1:1 to the glabrous skin of small test animals,
(ii) applying water to the glabrous skin to which the organic solvent was applied,
(iii) for a test group, applying a test substance to the glabrous skin of the test animals to which the water was applied,
(iv) repeating treatments (i) for 10 to 60 seconds, and (ii) for 30 to 60 seconds for a control group for several days and repeating treatments (i) for 10 to 60 seconds, (ii) for 30 to 60 seconds and treatment (iii) for the test group for several days,
(v) comparing the number of itch-associated action of the animals of the test group with that of the animals of the control group, and
(vi) judging the test substance to be effective in improving skin care products when the number of itch-associated action of the animals of the test group is statistically significantly smaller than that of the animals of the control group.

20. A method for evaluating a test substance to improve skin care products, which comprises,
(i) applying a mixture of acetone and diethylether in a ratio of 1:1 to the glabrous skin of small test animals, the area of the glabrous skin being about 40% to 80% based on the width or height of the animals,
(ii) applying water to the glabrous skin to which the organic solvent was applied,
(iii) for a test group, applying a test substance to the glabrous skin to which the water was applied,
(iv) repeating treatments (i) for 10 to 60 seconds, and (ii) for 30 to 60 seconds for several days for a control group and repeating treatments (i) for 10 to 60 seconds, (ii) for 30 to 60 seconds and treatment (iii) for several days for the test group,
(v) comparing the number of itch-associated action of the animals of the test group with that of the animals of the control group, and
(vi) judging the test substance to be effective in improving skin care products when the number of itch-associated action of the animals of the test group is statistically significantly smaller than that of the animals of control group.
